(19) United States
(12) Patent Application Publication
(10) Pub. No.: US 2010/0292834 A1
(43) Pub. Date: Nov. 18, 2010

(54) APPLIED TO A CONTINUOUS EGG GRADER MACHINE

(75) Inventor: André Luiz de Aguiar Mirandola, Centro Rinópolis/SP (BR)

Correspondence Address: SCHMEISER, OLSEN & WATTS, 22 CENTURY HILL DRIVE, SUITE 302, LATHAM, NY, 12110, US

(73) Assignee: NELSON YAMASAKI, Rinópolis/SP (BR)

(21) Appl. No.: 12/630,861

(22) Filed: Dec. 4, 2009

(30) Foreign Application Priority Data
May 12, 2009 (BR) PI 0901689-9

(51) Int. Cl. A01K 43/04

(52) U.S. Cl. 700/223

(57) ABSTRACT

The present invention discloses a novel improvement applied to egg grader machines used in poultry farms and the like. Said continuous egg grader machine differs from other egg grader machines because it does not comprise the above-mentioned 90-degree curve existing in the egg circuit, i.e., the continuous egg grader machine of the present invention comprises a completely continuous linear circuit, wherein the great advantage of using the continuous egg grader machine disclosed herein is related to the gain obtained by the egg reduced speed when multiple rows of eggs are provided.

### FIELD OF THE INVENTION

The present invention refers to a novel improvement applied to egg grader machines used in poultry farms and the like. The continuous egg grader machine disclosed herein is able to process eggs quickly, but with egg reduced speed, when compared to congener grader machines belonging to the current state-of-the-art.

### BACKGROUND OF THE INVENTION

The current state of the art provides various types and models of egg grader machines, wherein the egg grader machines of this same Applicant stand out among such diversity.

One of the Patent Applications filed by this same applicant, mainly the Brazilian Patent Application PI 0701960-2, entitled “Arrangement for Egg Grader Machine Provided with Belt Conveyor”, discloses a spontaneous improvement in relation to the machine disclosed in the Brazilian Patent Application PI 0605533-8. Therefore, said egg grader machine provided with belt conveyor, which is designed to carry the eggs to package unit outlets, comprises an integrated egg candling system, an egg belt conveyor, an egg outlet belt, and an integrated egg packaging system. Although it is totally effective and fulfills what it was designed to do, said egg grader machine of the Brazilian Patent Application PI 0701960-2 has still some points to be improved, which were solved by the improvement applied to an egg grader machine, whose application was filed on 16 Mar. 2009, under the preliminary number SP 018,090,012,931.

Said application SP 018,090,012,931 discloses an egg grader machine provided with multiple belt conveyors, which facilitates the distribution of eggs previously graded, increasing even more the speed egg processing, without the need for effective expansion of the machine dimensions. The great advantage obtained now refers to the possibility of multiplying the production by a novel machine that has conventionally dimensions similar to those of congener machines belonging to the current state-of-the-art. Although it is totally functional and effective in what it was designed to do, it is noticeable that this machine occupy a relatively big area, since the inlet and the candling of eggs are carried out in one direction (longitudinal, for example), while the outlet of eggs is carried out in other direction (latitudinal, for example), i.e., eggs follow a circuit that has, at a certain point, a sharp 90-degree curve. Depending on the number of egg outlets, the second part of the circuit (the part posterior to the 90-degree curve) can be disproportional to the first part of the circuit. Consequently, this configuration may be undesirable in sites with limited space. Based on this context, the present invention was developed.

### SUMMARY OF THE INVENTION

The present invention, which was developed in order to optimize the aforementioned concepts, as well as the production, discloses a novel improvement applied to a continuous egg grader machine.

The continuous egg grader machine of the present invention differs from the other egg grader machines because it does not comprise the above-mentioned 90-degree curve existing in the egg circuit, i.e., the continuous egg grader machine of the present invention comprises a completely continuous linear circuit.

For that reason, it is also implemented a new, revolutionary and innovative egg expulsion system.

The great advantage of using the continuous egg grader machine disclosed herein is related to the gain obtained by the egg reduced speed when multiple rows of eggs are provided.

The continuous egg grader machine of the present invention is especially ideal to process from twelve to eighteen rows of eggs, but it may also be suitable to process six or eight rows of eggs.

### BRIEF DESCRIPTION OF THE DRAWINGS

The present invention will be now described in detail with references to the accompanying drawing, in which:

FIG. 1 schematically illustrates, in plan view, the continuous egg grader machine of the present invention, and;

FIG. 2 illustrates schematically the circuit to which eggs are submitted when introduced into the continuous egg grader machine of the present invention.

### DETAILED DESCRIPTION OF THE INVENTION

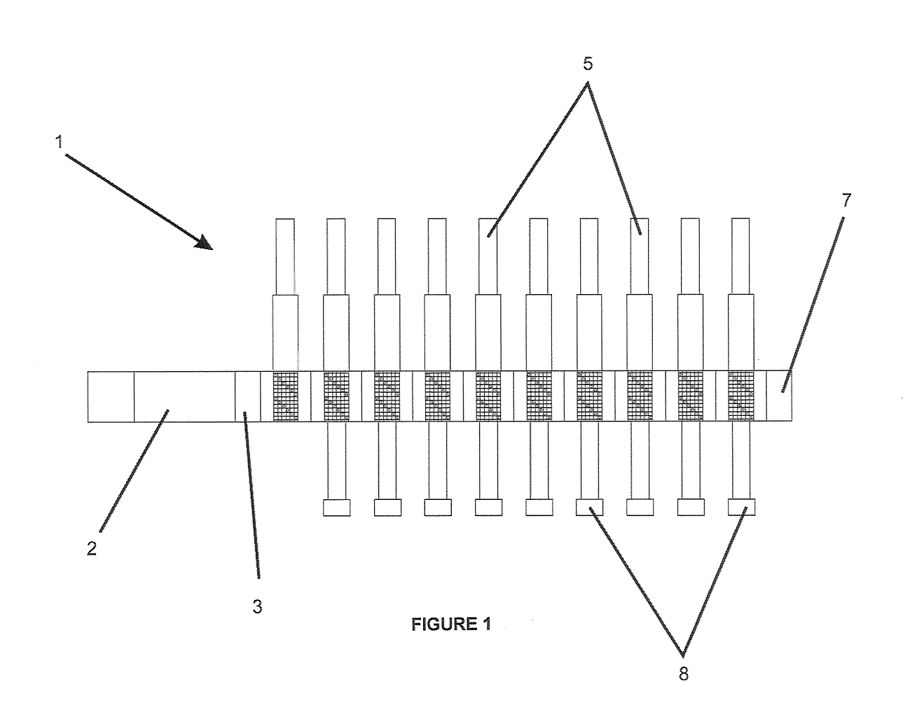

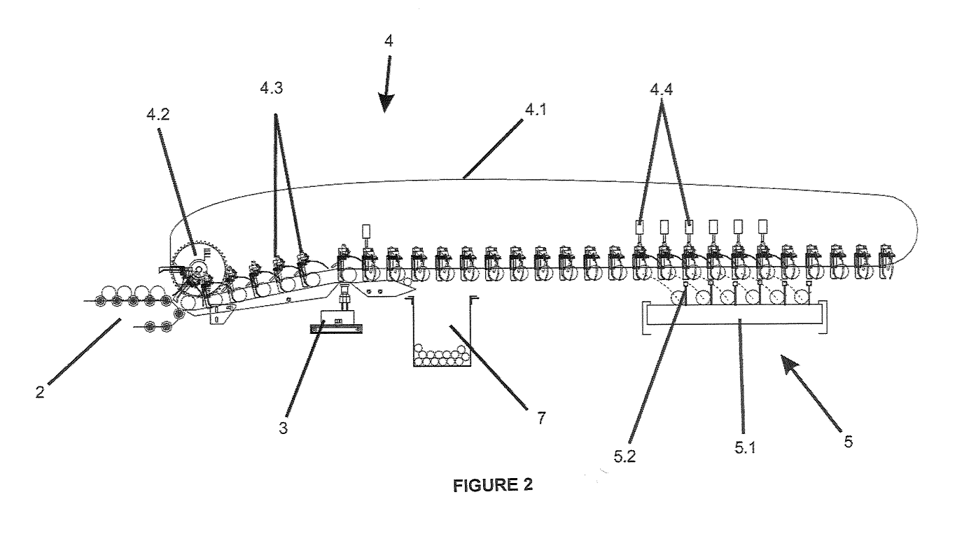

As illustrated in FIGS. 1 and 2, the continuous egg grader machine of the present invention, hereinafter referred to as (1), comprises at least an optical egg candling module (2), at least a weighing module (3), an egg conveyor system (4), at least an egg outlet (5), and an electronic central processing unit (6). Said optical egg candling module (2) and said weighing module (3) are essentially conventional.

Said continuous and linear conveyor system (4) is composed of a gear-driven close belt (4.2). Said conveyor system (4) is also composed of a plurality of claws (4.3) arranged in multiple rows. Each of the claws (4.3) has an individual locking system responsible for opening or locking said claws (4.3).

Said conveyor system (4) comprises multiple solenoids (4.4) that are responsible for interaction with the locking system of each claw (4.3). Said solenoids (4.4) are arranged diagonally and located on the egg outlets (5) to the conveyor belt (5.1).

Said egg outlet (5) is a conveyor belt (5.1) that begins below the conveyor system (4) in transversal direction. Thus, said conveyor belt (5.1) also contains just below the conveyor system (4) a dampening system (5.2) responsible for the dampening of eggs coming from said conveyor system (4).

It should also be noted that, in a preferred configuration, the continuous egg grader machine of the present invention (1) comprises a plurality of egg outlets (5), wherein each egg outlet is used to an egg specification (for example, egg weight). In this situation, said conveyor system (4) comprises a set of solenoids (4.4) on each egg outlet (5).

The continuous egg grader machine of the present invention (1) also comprises an outlet (7) for out-of-specification eggs (or for eggs that were not graded correctly, if a problem occurred in the egg outlet).

In addition to these components, the continuous egg grader machine of the present invention (1) comprises tray storage units (8) for storage of eggs.

Since the buildability of the continuous egg grader machine of the present invention (1) is basic, the understanding of its correct operation becomes clear, i.e., eggs are placed (manually or automatically) in the optical egg candling module (2), where a screening of said eggs is performed. Then, eggs are weighed in the weighing module (3), and the weighing data is stored in the electronic central processing unit (6). Then, eggs are sent to the conveyor system (4). In the conveyor system (4), all eggs are collected by the claws (4.3), wherein only one egg is collected by each grab (4.3). Said claws (4.3), which are duly connected to the close belt (4.1) and consequently to its movement, convey continuously eggs to their respective outlets defined by the weighing data.

Therefore, the electronic central processing unit (6), which constantly monitors the whole process, is responsible for trigging the solenoid (4.4) and thus, when a particular egg that is still gripped by a claw (4.3) passes over its respective egg outlet (5), said electronic central processing unit (6) triggers the solenoid (4.4), and due to the mechanical action (interaction with the individual locking system of each claw (4.3)), the solenoid (4.4) opens said claw (4.3), which causes firstly the egg to be dispensed in the dampening system (5.2), and then said egg flows to the conveyor belt (5.1).

It should also be noted that, in order to preclude the accumulation of eggs in the dampening system (5.2), said solenoids (4.4) are arranged diagonally. Thus, if an entire row of eggs is dispensed in a single egg outlet (5), these eggs will be dispensed in an inclined-way, as better illustrated in FIG. 2.

1. An improvement applied to a continuous egg grader machine comprising of at least an optical egg candling module (2), at least a weighing module (3), an egg conveyor system (4), at least an egg outlet (5), and an electronic central processing unit (6), wherein said conveyor system (4) is continuous and linear, and consists of a close belt (4.1) driven by gears (4.2); said conveyor system (4) is also composed of a plurality of claws (4.3) arranged in multiple rows, wherein each of the claws (4.3) (4.3) has an individual locking system responsible for opening or locking said claws (4.3); said conveyor system (4) also comprises multiple solenoids (4.4) that are responsible for interaction with the locking system of each claw (4.3); the egg outlet (5) is a conveyor belt (5.1) that begins below the conveyor system (4) in transversal direction, and; the continuous egg grader machine (1) also comprises an outlet (7) for out-of-specification eggs.

2. An improvement applied to a continuous egg grader machine according to claim 1 wherein said solenoids (4.4) are arranged diagonally and located on the egg outlets (5) to the conveyor belt (5.1).

3. An improvement applied to a continuous egg grader machine according to claim 1 wherein the conveyor belt (5.1) also contains just below the conveyor system (4) a dampening system (5.2) responsible for the dampening of eggs coming from said conveyor system (4).

4. An improvement applied to a continuous egg grader machine according to claim 1, wherein in a preferred configuration, the continuous egg grader machine (1) comprises a plurality of egg outlets (5), wherein each egg outlet is used to an egg specification, and in this situation, said conveyor system (4) comprises a set of solenoids (4.4) on each egg outlet (5).

5. An improvement applied to a continuous egg grader machine according to claim 1, wherein the continuous egg grader machine (1) also comprises tray storage units (8) for eggs storage.

6. An improvement applied to a continuous egg grader machine according to claim 1, wherein said electronic central processing unit (6) is responsible for trigging the solenoid (4.4).

7. An improvement applied to a continuous egg grader machine according to claim 1, wherein eggs are introduced into the optical egg candling module (2), where a screening of said eggs is performed, then, said eggs are weighed in the weighing module (3), the weighing data is stored in the electronic central processing unit (6) and then said eggs are sent to the conveyor system (4); in said conveyor system (4), all eggs are collected by the claws (4.3), wherein only one egg is collected by each grab (4.3); said claws (4.3), which are duly connected to the close belt (4.1), convey continuously eggs to their respective outlets defined by the weighing data, and when a particular egg that is still gripped by a claw (4.3) passes over its respective egg outlet (5), said electronic central processing unit (6) triggers the solenoid (4.4), and due to the mechanical action, said solenoid (4.4) opens said claw (4.3), which causes firstly the egg to be dispensed in the dampening system (5.2) and then said egg flows to the conveyor belt (5.1).
